(19) United States
(12) Patent Application Publication
(10) Pub. No.: US 2023/0329222 A1
(43) Pub. Date: Oct. 19, 2023

(54) ELECTRIC MOUSE KILLER

(71) Applicant: MING YANG, DONGGUAN (CN)

(72) Inventor: MING YANG, DONGGUAN (CN)

(21) Appl. No.: 17/659,477

(22) Filed: Apr. 15, 2022

(51) Int. Cl. A01M 23/38; A01M 23/16

(52) U.S. Cl. CPC A01M 23/38; A01M 23/16

(57) ABSTRACT

The present invention discloses an electric mouse killer, comprising an electric mouse killer main body and an electric mouse compartment, wherein the electric mouse killer main body comprises a housing, a circuit board, a battery, a high-voltage pack and a high-voltage contact piece, the electric mouse compartment comprises a compartment body and a high-voltage conductive medium, and a plug-in port of the compartment body is connected to a plug-in end of the housing.

### TECHNICAL FIELD

The present invention relates to the technical field of mouse trapping and killing, and more particularly to an electric mouse killer.

### BACKGROUND

Mice eat food and spread disease, and have highly reproductive power and are harmful to human beings, so eradicating mice is a long-term task for human beings. Traditional mousetrap can only trap mice, and how to deal with the trapped mice is a difficult problem. At present there are some electric mouse killers on the market that can convert AC or DC low-voltage electricity into high-voltage electricity, and the mice can be killed by corona when they encounter high voltage. However, the existing electric mouse killers are generally of an integrated structure, whose compartment bodies cannot be disassembled, which are bulky and increase the transportation cost. When the mice are electrified, urine stains and dirt will be left, which need to be cleaned every time before the electric mouse killers can be used again, which is not conducive to the health of users.

### SUMMARY

It is an object of the present invention to overcome the above-mentioned defects of the prior art and to provide an electric mouse killer.

In order to achieve the above object, the present invention provides an electric mouse killer, comprising:

an electric mouse killer main body comprising a housing, a circuit board, a battery, a high-voltage pack for generating high-voltage electricity and at least two high-voltage contact pieces, the circuit board, battery and high-voltage pack are respectively mounted inside the housing, all the high-voltage contact pieces are respectively mounted on a plug-in end of the housing, and the battery, high-voltage pack and high-voltage contact pieces are respectively electrically connected to the circuit board;

an electric mouse compartment comprising a compartment body and at least two high-voltage conductive media, the compartment body is provided as a hollow structure, one end of the compartment body is opened to form a mouse inlet, the other end of the compartment body is opened to form a plug-in port, the plug-in port of the compartment body is connected to a plug-in end of a housing, all the high-voltage conductive media are respectively mounted on the bottom surface of the inner wall of the compartment body, and each high-voltage conductive medium is respectively in contact connection with a respective corresponding high-voltage contact piece.

Three of the high-voltage contact pieces are provided, a first high-voltage contact piece is mounted on one side of the plug-in end of the housing, a second high-voltage contact piece is mounted on the other side of the plug-in end of the housing, and a third high-voltage contact piece is mounted on a bottom end of the plug-in end of the housing; three of the high-voltage conductive media are provided, a first high-voltage conductive medium, a second high-voltage conductive medium and a third high-voltage conductive medium are respectively arranged at intervals in a direction of the plug-in port of the compartment body, the first high-voltage conductive medium is in contact connection with the first high-voltage contact piece via a first medium extension portion connected to one side of an inner wall of the compartment body, the second high-voltage conductive medium is in contact connection with the second high-voltage contact piece via a second medium extension portion connected to the other side of the inner wall of the compartment body, and the third high-voltage conductive medium is in direct contact connection with the third high-voltage contact piece.

A first high-voltage conductive medium is a high-voltage negative electrode, a second high-voltage conductive medium is a high-voltage positive electrode, and a third high-voltage conductive medium is a high-voltage negative electrode for triggering.

All of the high-voltage conductive media are respectively provided as aluminum foils.

A plug-in end of the housing is provided with a bait placement.

A plug-in end of the housing is provided with a first compartment body positioning block longitudinally mounted on one side of a plug-in end of the housing, a second compartment body positioning block longitudinally mounted on the other side of the plug-in end of the housing, and a third compartment body positioning block horizontally mounted on a bottom end of the plug-in end of the housing, the third compartment body positioning block is connected between the first compartment body positioning block and the second compartment body positioning block; a top of the plug-in end of the housing is provided with a housing extension portion extending in the direction of the electric mouse compartment, an upper end of the first compartment body positioning block and an upper end of the second compartment body positioning block form a compartment body insertion gap with the housing extension portion, the compartment body is provided in a square shape, and when the plug-in port of the compartment body is connected to the plug-in end of the housing, the first compartment body positioning block, the second compartment body positioning block and the third compartment body positioning block are all inserted into the interior of the compartment body from the plug-in port of the compartment body, and an upper end portion of the plug-in port of the compartment body is inserted into the compartment body insertion gap.

A plug-in end of the housing is provided with an electric mouse compartment insertion detection switch electrically connected to a circuit board, and when the plug-in port of the compartment body is connected to the plug-in end of the housing, the compartment body is in contact with the electric mouse compartment insertion detection switch, so that the electric mouse compartment insertion detection switch is in an on state.

The housing is provided with a power source main switch and a power indicator lamp, the power source main switch and the power indicator lamp being electrically connected to the circuit board, respectively.

The battery is mounted inside a battery compartment provided at a bottom of the housing, the bottom of the housing being provided with a battery compartment cover.

The compartment body is configured as a disposable foldable paper compartment body.

Compared to the prior art, the advantageous effects of the present invention are:

The present invention has a simple structure, a reasonable design and a small volume; when a mouse touches at least two high-voltage conductive media, a high-voltage pack can generate high-voltage electricity and transmit same to all the high-voltage conductive media; the mouse is electrocuted by high-voltage electricity, with high efficiency; and the electric mouse compartment and electric mouse killer main body can be detachably connected, so that the mouse and the electric mouse compartment can be thrown away together after the mouse is electrocuted, thereby reducing the contact with the mouse, clean and sanitary, easy to use and safe.

A disposable foldable paper compartment body is adopted by the electric mouse compartment of the present invention, which can reduce the volume after being folded and facilitate transportation and storage.

The present invention is provided with an electric mouse compartment insertion detection switch and a power source main switch, only after the electric mouse compartment is inserted and the power source main switch is turned on, high-voltage electricity is generated in the entire electric mouse killer, and when the electric mouse compartment is removed, even if the power source main switch is turned on, high-voltage electricity is not generated, which can prevent a user from electric shock and improve the safety performance of the electric mouse killer.

### BRIEF DESCRIPTION OF DRAWINGS

FIG. 1 is a schematic view showing a structure of an electric mouse killer.

FIG. 2 is a schematic view showing a structure of an electric mouse killer main body.

FIG. 3 is a schematic view showing an internal structure of an electric mouse killer main body.

FIG. 4 is a schematic view showing a bottom structure of an electric mouse killer main body after the battery compartment cover is hidden.

FIG. 5 is a first schematic view showing a structure of an electric mouse compartment.

FIG. 6 is a second schematic view showing a structure of an electric mouse compartment.

FIG. 7 is a schematic view showing a structure of an electric mouse compartment after being folded.

FIG. 8 is a schematic circuit diagram of an electric mouse killer.

### DETAILED DESCRIPTION

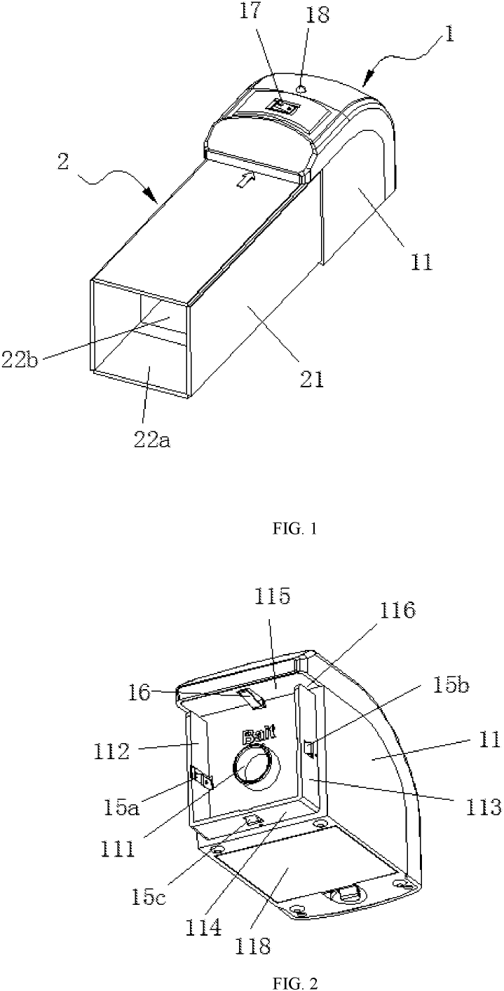

Referring to FIG. 1, an embodiment of the present invention provides an electric mouse killer, comprising an electric mouse killer main body 1 and an electric mouse compartment 2, and various components of the embodiment will be described in detail with reference to the accompanying drawings.

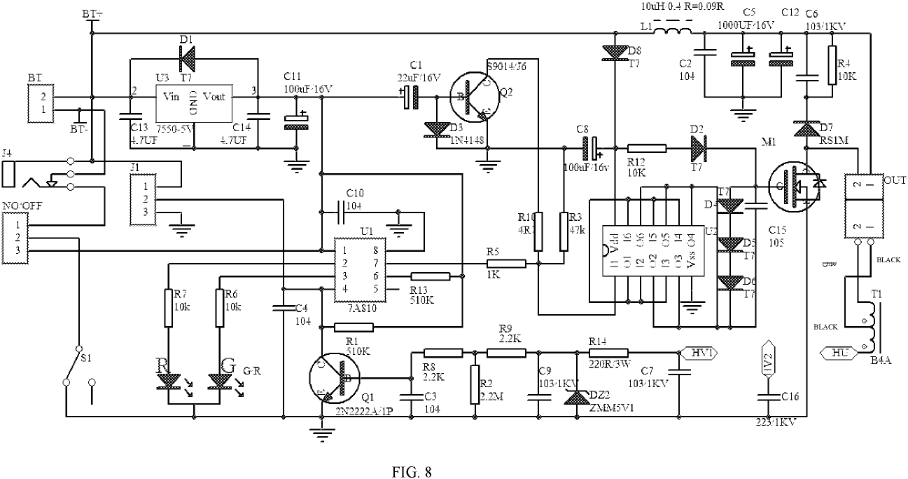

As shown in FIGS. 2 and 3, an electric mouse killer main body 1 may comprise a housing 11, a circuit board 12, a battery 13, a high-voltage pack 14 for generating high-voltage electricity (also referred to as a high-voltage generator or a line output transformer) and high-voltage contact pieces 15a, 15b and 15c, and the battery 13, the high-voltage pack 14 and the high-voltage contact pieces 15a, 15b and 15c are respectively electrically connected to the circuit board 12 (as shown in FIG. 8).

The circuit board 12 and the high-voltage pack 14 are respectively mounted inside the housing 11, and the high-voltage contact pieces 15a, 15b and 15c are respectively mounted on the plug-in end of the housing 11. As shown in FIG. 2, preferably, the high-voltage contact piece 15a may be mounted on one side (e.g., left side) of the plug-in end of the housing 11, the high-voltage contact piece 15b is mounted on the other side (e.g., right side) of the plug-in end of the housing 11, and the third high-voltage contact piece 15 is mounted on a bottom end of the plug-in end of the housing 11. Wherein, the high-voltage contact pieces 15a, 15b and 15c may adopt a spring piece structure, which facilitates contact with a high-voltage conductive medium.

As shown in FIG. 2, the plug-in end of the housing 11 may be provided with a bait placement 111, which may take the form of a circular ring. In operation, peanut butter or other bait may be applied at the bait placement 111.

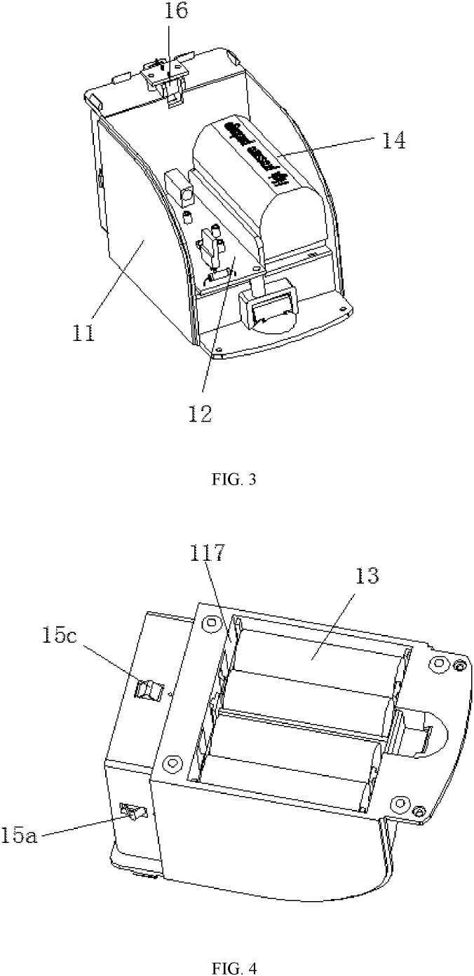

As shown in FIGS. 2 and 4, the battery 13 may preferably be four AA batteries, and the battery 13 is mounted inside a battery compartment 117 provided at the bottom of the housing 11, and the bottom of the housing 11 is provided with a battery compartment cover 118.

As shown in FIG. 2, the plug-in end of the housing 11 may be provided with a first compartment body positioning block 112 longitudinally mounted on one side (e.g., left side) of a plug-in end of the housing 11, a second compartment body positioning block 113 longitudinally mounted on the other side (e.g., right side) of the plug-in end of the housing 11, and a third compartment body positioning block 114 horizontally mounted on a bottom end of the plug-in end of the housing 11, the third compartment body positioning block 114 is connected between the first compartment body positioning block 112 and the second compartment body positioning block 113; a top of the plug-in end of the housing 11 is provided with a housing extension portion 115 extending in the direction of the electric mouse compartment 2, and an upper end of the first compartment body positioning block 112 and an upper end of the second compartment body positioning block 113 form a compartment body insertion gap 116 with the housing extension portion 115. Wherein, the designs of the first compartment body positioning block 112, the second compartment body positioning block 113, the third compartment body positioning block 114 and the housing extension portion 115 facilitate the connection and positioning between the housing and the electric mouse compartment. Preferably, the high-voltage contact piece 15a may protrude at the through hole of the first compartment body positioning block 112, the high-voltage contact piece 15b may protrude at the through hole of the second compartment body positioning block 113, and the high-voltage contact piece 15c may protrude at the through hole of the third compartment body positioning block 114.

As shown in FIGS. 2, 3 and 8, a plug-in end of the housing 11 is provided with an electric mouse compartment insertion detection switch 16 (e.g., a micro-switch) electrically connected to a circuit board 12, and when the plug-in port of the compartment body 21 is connected to the plug-in end of the housing 11, the compartment body 21 is in contact with the electric mouse compartment insertion detection switch 16, so that the electric mouse compartment insertion detection switch 16 is in an on state.

In this embodiment, preferably, the contact portion of the electric mouse compartment insertion detection switch 16 may be located at the bottom of the housing extension portion 115. At this time, the contact portions of the high-voltage contact pieces 15a, 15b and 15c and the electric mouse compartment insertion detection switch 16 can be pressed against the periphery of the compartment body 21, respectively, so as to achieve a better connection and positioning between the housing and the electric mouse compartment, and to prevent the electric mouse compartment from being easily separated from the electric mouse killer main body.

As shown in FIGS. 1 and 8, the housing 11 is provided with a power source main switch 17 and a power indicator lamp 18, and the power source main switch 17 and the power indicator lamp 18 are electrically connected to the circuit board 12, respectively.

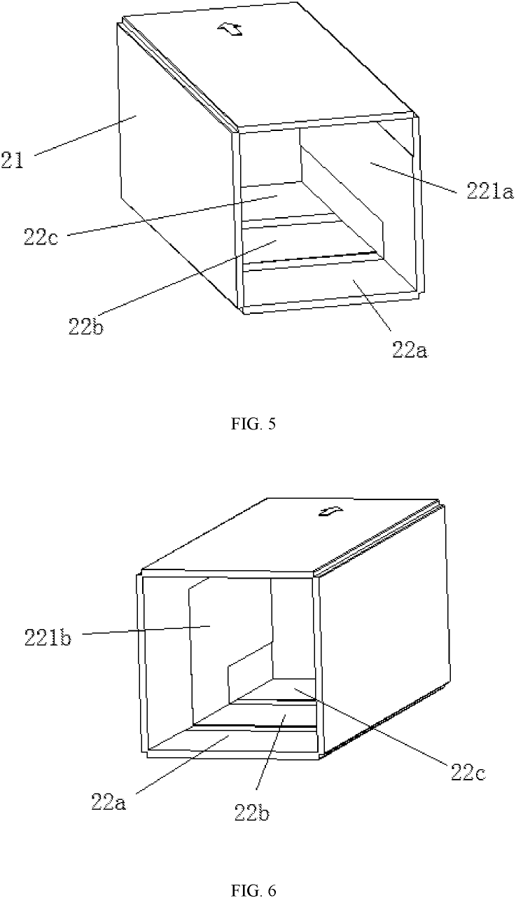

As shown in FIGS. 5 and 6, the electric mouse compartment 2 may comprise a compartment body 21 and high-voltage conductive media 22a, 22b and 22c; the compartment body 21 may be provided as a square hollow structure; one end of the compartment body 21 is opened to form a mouse inlet; the other end of the compartment body 21 is opened to form a plug-in port; and the plug-in port of the compartment body 21 is connected to the plug-in end of the housing 11.

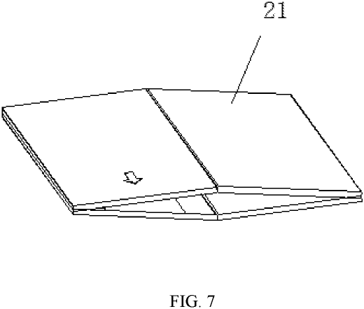

As a further improvement of this embodiment, the compartment body 21 may preferably be provided as a disposable foldable paper compartment body. As shown in FIG. 7, the compartment body 21 may be folded into a flat shape, which can reduce the volume after being folded and facilitate transportation and storage.

It should be noted herein that the compartment body 21 may also be a disposable foldable compartment body made of other materials, such as a foldable plastic compartment body, according to practical requirements.

As shown in FIGS. 5 and 6, the high-voltage conductive media 22a, 22b and 22c are respectively mounted on the bottom surface of the inner wall of the compartment body 21; the high-voltage conductive media 22a, 22b and 22c are respectively arranged at intervals in the direction of the plug-in port of the compartment body 21; the high-voltage conductive medium 22a may be in contact connection with the high-voltage contact piece 15a via a first medium extension portion 221a connected to one side of the inner wall of the compartment body 21; the high-voltage conductive medium 22b may be in contact connection with the high-voltage contact piece 15b via a second medium extension portion 221b connected to the other side of the inner wall of the compartment body 21; and the high-voltage conductive medium 22c is in direct contact connection with the third high-voltage contact piece 15c.

Wherein, the high-voltage conductive medium 22a may be provided as a high-voltage negative electrode, the high-voltage conductive medium 22b may be provided as a high-voltage positive electrode, and the high-voltage conductive medium 22c may be provided as a high-voltage negative electrode for triggering.

When the mouse enters the electric mouse compartment for food, it may firstly touch the high-voltage conductive medium 22a and the high-voltage conductive medium 22b, which may not immediately connect the high-voltage electricity; but when the mouse moves inwards further and touches the high-voltage conductive medium 22b and the high-voltage conductive medium 22c, the high-voltage conductive media 22a, 22b and 22c will connect the high-voltage electricity (e.g., 8000 V), electrocuting the mouse.

Due to the high alertness and agility of mice, if only two high-voltage conductive media are provided, mice try to eat the bait and may escape immediately after the high voltage is triggered; and if three high-voltage conductive media are provided, even if the high-voltage conductive media 22b and 22c located inside do not electrocute the mice, the high-voltage conductive medium 22a located on the outside can also electrocute the mice running back, which is beneficial to block the retreat route of the mice, and can further improve the efficiency of electrocuting the mice.

Preferably, the high-voltage conductive media 22a, 22b and 22c may be respectively provided as aluminum foils, which are easy to assemble, light and thin, and can reduce the weight of the electric mouse compartment.

During operation, the bait may be put on the bait placement 111 of the housing 11 firstly, and then the electric mouse compartment 2 is inserted; when the plug-in port of the compartment body 21 is connected to the plug-in end of the housing 11, the first compartment body positioning block 112, the second compartment body positioning block 113 and the third compartment body positioning block 114 are all inserted into the interior of the compartment body 21 from the plug-in port of the compartment body 21, the upper end portion of the plug-in port of the compartment body 21 is inserted into the compartment body insertion gap 116, the contact portions of the high-voltage contact pieces 15a, 15b and 15c and the electric mouse compartment insertion detection switch 16 are pressed against the periphery of the compartment body 21 respectively, and finally the operation of electrocuting the mice is started by turning on the power source main switch 17.

This embodiment is provided with an electric mouse compartment insertion detection switch and a power source main switch, only after the electric mouse compartment is inserted and the power source main switch is turned on, high-voltage electricity is generated in the entire electric mouse killer, and when the electric mouse compartment is removed, even if the power source main switch is turned on, high-voltage electricity is not generated, which can prevent a user from electric shock and improve the safety performance of the electric mouse killer.

In summary, the present invention has a simple structure, a reasonable design and a small volume; when a mouse touches a high-voltage conductive medium, a high-voltage pack can generate high-voltage electricity and transmit same to all the high-voltage conductive media; the mouse is electrocuted by high-voltage electricity, with high efficiency; and the electric mouse compartment and electric mouse killer main body can be detachably connected, so that the mouse and the electric mouse compartment can be thrown away together after the mouse is electrocuted, thereby reducing the contact with the mouse, clean and sanitary, easy to use and safe.

It should be noted herein that the number of the high-voltage contact pieces and the high-voltage conductive media may be provided as two or three or more, respectively, according to practical requirements, which is not a limitation of the present embodiment.

The embodiments described above are preferred embodiments of the present invention, but the embodiments of the present invention are not limited to the embodiments described above, and any other changes, modifications, substitutions, combinations and simplifications made without departing from the spirit and principles of the present invention are to be construed as equivalent substitutions within the scope of the present invention.

What is claimed is:

1. An electric mouse killer, comprising:
an electric mouse killer main body comprising a housing, a circuit board, a battery, a high-voltage pack for generating high-voltage electricity and at least two high-voltage contact pieces, wherein the circuit board, battery and high-voltage pack are respectively mounted inside the housing, all the high-voltage contact pieces are respectively mounted on a plug-in end of the housing, and the battery, high-voltage pack and high-voltage contact pieces are respectively electrically connected to the circuit board;
an electric mouse compartment comprising a compartment body and at least two high-voltage conductive media, wherein the compartment body is provided as a hollow structure, one end of the compartment body is opened to form a mouse inlet, the other end of the compartment body is opened to form a plug-in port, the plug-in port of the compartment body is connected to a plug-in end of a housing, all the high-voltage conductive media are respectively mounted on the bottom surface of the inner wall of the compartment body, and each high-voltage conductive medium is respectively in contact connection with a respective corresponding high-voltage contact piece.

2. The electric mouse killer of claim 1, wherein three of the high-voltage contact pieces are provided, a first high-voltage contact piece is mounted on one side of the plug-in end of the housing, a second high-voltage contact piece is mounted on the other side of the plug-in end of the housing, and a third high-voltage contact piece is mounted on a bottom end of the plug-in end of the housing; three of the high-voltage conductive media are provided, a first high-voltage conductive medium, a second high-voltage conductive medium and a third high-voltage conductive medium are respectively arranged at intervals in a direction of the plug-in port of the compartment body, the first high-voltage conductive medium is in contact connection with the first high-voltage contact piece via a first medium extension portion connected to one side of an inner wall of the compartment body, the second high-voltage conductive medium is in contact connection with the second high-voltage contact piece via a second medium extension portion connected to the other side of the inner wall of the compartment body, and the third high-voltage conductive medium is in direct contact connection with the third high-voltage contact piece.

3. The electric mouse killer of claim 2, wherein a first high-voltage conductive medium is a high-voltage negative electrode, a second high-voltage conductive medium is a high-voltage positive electrode, and a third high-voltage conductive medium is a high-voltage negative electrode for triggering.

4. The electric mouse killer of claim 1, wherein all of the high-voltage conductive media are respectively provided as aluminum foils.

5. The electric mouse killer of claim 1, wherein a plug-in end of the housing is provided with a bait placement.

6. The electric mouse killer of claim 1, wherein a plug-in end of the housing is provided with a first compartment body positioning block longitudinally mounted on one side of a plug-in end of the housing, a second compartment body positioning block longitudinally mounted on the other side of the plug-in end of the housing, and a third compartment body positioning block horizontally mounted on a bottom end of the plug-in end of the housing, the third compartment body positioning block is connected between the first compartment body positioning block and the second compartment body positioning block; a top of the plug-in end of the housing is provided with a housing extension portion extending in the direction of the electric mouse compartment, an upper end of the first compartment body positioning block and an upper end of the second compartment body positioning block form a compartment body insertion gap with the housing extension portion, the compartment body is provided in a square shape, and when the plug-in port of the compartment body is connected to the plug-in end of the housing, the first compartment body positioning block, the second compartment body positioning block and the third compartment body positioning block are all inserted into the interior of the compartment body from the plug-in port of the compartment body, and an upper end portion of the plug-in port of the compartment body is inserted into the compartment body insertion gap.

7. The electric mouse killer of claim 1, wherein a plug-in end of the housing is provided with an electric mouse compartment insertion detection switch electrically connected to a circuit board, and when the plug-in port of the compartment body is connected to the plug-in end of the housing, the compartment body is in contact with the electric mouse compartment insertion detection switch, so that the electric mouse compartment insertion detection switch is in an on state.

8. The electric mouse killer of claim 1, wherein the housing is provided with a power source main switch and a power indicator lamp, the power source main switch and the power indicator lamp being electrically connected to the circuit board, respectively.

9. The electric mouse killer of claim 1, wherein the battery is mounted inside a battery compartment provided at a bottom of the housing, the bottom of the housing being provided with a battery compartment cover.

10. The electric mouse killer of claim 1, wherein the compartment body is configured as a disposable foldable paper compartment body.
